(19) United States
(12) Patent Application Publication
(10) Pub. No.: US 2026/0054258 A1
(43) Pub. Date: Feb. 26, 2026

(54) METHODS FOR MAKING MESOPOROUS NANO-SIZED ZEOLITE BETA THAT UTILIZE HEATING UNDER INERT GAS

(71) Applicant: Saudi Arabian Oil Company, Dhahran (SA)

(72) Inventors: Batool Altaher, Dammam (SA); Lianhui Ding, Dhahran (SA); Faisal Alotaibi, Al Khobar (SA); Mohammed Z. Al-Bahar, Dhahran (SA); Faisal M. Almulla, Dhahran (SA)

(73) Assignee: Saudi Arabian Oil Company, Dhahran (SA)

(21) Appl. No.: 18/811,154

(22) Filed: Aug. 21, 2024

(51) Int. Cl. B01J 29/70; B01J 35/45; B01J 35/61; B01J 35/63; B01J 35/70; B01J 37/00; B01J 37/02; B01J 37/06; B01J 37/10; B82Y 35/00; B82Y 40/00; C01B 39/04

(52) U.S. Cl. CPC B01J 29/7007; B01J 35/45; B01J 35/617; B01J 35/635; B01J 35/70; B01J 37/0018; B01J 37/0201; B01J 37/06; B01J 37/10; B82Y 35/00; B82Y 40/00; C01B 39/04

(57) ABSTRACT

A method for making nano-sized mesoporous zeolite Beta may include heating, in an environment including 99 mol. % or greater inert gas, a precursor nano-sized zeolite Beta to form an inert gas-treated nano-sized mesoporous zeolite Beta intermediate material. The inert gas may be chosen from nitrogen, helium, argon, or combinations thereof. The method may further include heating, in an environment including 10 mol. % or greater oxygen gas, the inert gas-treated nano-sized mesoporous zeolite Beta intermediate material to form the nano-sized mesoporous zeolite Beta.

### BACKGROUND

### Field

The present disclosure generally relates to porous materials and, more particularly, to zeolites.

### Technical Background

There are numerous zeolitic materials, which are classified by framework type and composition. Once such zeolitic material is zeolite Beta, which is a type of crystallized aluminosilicate zeolite that is widely used in heavy oil conversion processes such as hydrocracking and fluid catalytic cracking. The feedstock to these processes can be, for example, a portion of crude oil that has an initial boiling point of 350 Celsius (° C.) and an average molecular weight ranging from about 200 to 600, or greater. As such, zeolite Beta has an important use in industry in crude oil refining, and beyond.

### BRIEF SUMMARY

As described herein, conventional nano-sized mesoporous zeolite Beta have been generated where, in some embodiments, a step of heating in air is utilized (i.e., calcining). It has been presently discovered that such heating steps reduce crystallinity of the nano-sized mesoporous zeolite Beta, according to one or more embodiments. Such reducing in crystallinity is undesirable. Embodiments described herein may utilize a heating under inert gas prior to any heating in air, which may, surprisingly, better preserve crystallinity of the zeolite.

In accordance with one embodiment of the present disclosure, a method for making nano-sized mesoporous zeolite Beta may comprise heating, in an environment comprising 99 mol. % or greater inert gas, a precursor nano-sized zeolite Beta to form an inert gas-treated nano-sized mesoporous zeolite Beta intermediate material. The inert gas may be chosen from nitrogen, helium, argon, or combinations thereof. The method may further comprise heating, in an environment comprising 10 mol. % or greater oxygen gas, the inert gas-treated nano-sized mesoporous zeolite Beta intermediate material to form the nano-sized mesoporous zeolite Beta.

Additional features and advantages of the technology disclosed herein will be set forth in the detailed description which follows, and in part will be readily apparent to those skilled in the art from that description or recognized by practicing the technology as described herein, including the detailed description which follows, as well as the appended claims.

It is to be understood that both the foregoing general description and the following detailed description present embodiments of the technology, and are intended to provide an overview or framework for understanding the nature and character of the technology as it is claimed. Additionally, following descriptions are meant to be merely illustrative, and are not intended to limit the scope of the claims in any manner.

### BRIEF DESCRIPTION OF THE DRAWINGS

The following detailed description of specific embodiments of the present disclosure can be best understood when read in conjunction with the following drawing, where like structure is indicated with like reference numerals and in which:

FIG. 1 depicts a graph showing ²⁷Al NMR analysis data, according to one or more examples described in this disclosure.

### DETAILED DESCRIPTION

The present disclosure describes various embodiments for making nano-sized mesoporous zeolite Beta that utilize an heating step in a high inert gas concentration environment prior to a heating step in the presence of oxygen, such as in air. As described herein, according to the presently disclosed methods, in an initial heating step, a precursor nano-sized zeolite Beta may be heated in an environment comprising 99 mol. % or greater inert gas, such as nitrogen, argon, or helium, which forms an inert gas-treated nano-sized mesoporous zeolite Beta intermediate material. Subsequently, the inert gas-treated nano-sized mesoporous zeolite Beta intermediate material may be heated in an environment comprising 10 mol. % or greater oxygen gas, which forms a nano-sized mesoporous zeolite Beta. As is described herein, according to some embodiments, the heating under inert gas may comprise a first heating stage and a second heating stage.

After forming a nano-size zeolite Beta, a heating step may be needed to remove organic materials that are in the zeolitic pores, such as templating agents used in the making of the precursor zeolite Beta. Conventional methods utilize a heating step in air (i.e., calcining) to remove such organic species. However, without being bound by any particular theory, it is believed that heating in air causes the precursor nano-sized zeolite Beta to create non-framework aluminum species, which is believed to reduce crystallinity of the zeolite Beta. Such reduced crystallinity is not desirable, and may cause lower efficiency for catalytic cracking of hydrocarbons.

However, it has been presently discovered that, rather than heating in air to remove organic species, a heating step in an inert gas-rich environment (e.g., substantially void of oxygen), followed by a heating step in the presence of oxygen, may increase crystallinity of the nano-sized zeolite Beta as compared with conventionally prepared calcined nano-sized zeolite Beta. Without being bound by theory, it is believed that the heating under inert gas burns off the majority of the organic components in the precursor zeolite Beta without producing water (steam), where the steam may have the propensity to dealuminate the precursor zeolite Beta, decreasing crystallinity. Then, a subsequent heating in oxygen (e.g., air) can burn off the remainder of the organic species without forming much steam. As compared with other conventional methods for making nano-sized mesoporous zeolite Beta having relatively high crystallinity, the presently disclosed methods may be simpler, cheaper, and easier scaled.

As used throughout this disclosure, and as would be understood by those skilled in the art, “zeolites” may refer to micropore-containing inorganic materials with regular intra-crystalline cavities and channels of molecular dimension. As is understood by those skilled in the art, and as used in this disclosure, “zeolite Beta” refers to a type of zeolite having a *BEA framework type according to the International Zeolite Association (“IZA”) zeolite nomenclature and consisting majorly of silica and alumina. The molar ratio of silica to alumina in the zeolite Beta may be 5 or greater, 10 or greater, 25 or greater, or even 100 or greater. For example, the molar ratio of silica to alumina in the zeolite Beta may be from 5 to 500, such as from 10 to 50. Silica to Alumina ratio can be measured by X-ray Fluorescence (“XRF”) spectrometry, as would be understood by those skilled in the art.

In one or more embodiments, the zeolites described herein may be “mesoporous zeolites,” which refers to zeolites that have an average pore size of from 2 nm to 50 nm (the mesoporous range as recognized by IUPAC). Zeolites generally comprise a crystalline structure, as opposed to an amorphous structure such as what may be observed in some porous materials such as amorphous silica. Zeolites generally include a microporous framework which may be identified by a framework type. The microporous structure of zeolites (e.g., 0.3 nm to 2 nm pore size) may render large surface areas and desirable size-/shape-selectivity, which may be advantageous for catalysis. In embodiments described herein, the zeolites may include micropores (present in the microstructure of a zeolite), and additionally include mesopores. As used throughout this disclosure, micropores refer to pores in a structure that have a diameter of less than or equal to 2 nm and greater than or equal to 0.1 nm, and mesopores refer to pores in a structure that have a diameter of greater than 2 nm and less than or equal to 50 nm. The average pore size, which is how pore sized is characterized herein unless stated otherwise, may be determined by Brunauer-Emmett-Teller (BET) analysis, which is a classification technique that is well understood by those skilled in the art.

As described herein, “nano-sized” refers to zeolitic particles and/or crystals that have an average particle size of less than or equal to 100 nm, where the average is utilized to classify size since the zeolitic particles, when produced, are generally dispersed in size in a distribution, such as a normal distribution. In some embodiments, the precursor mesoporous nano-sized zeolite Beta, calcined nano-sized mesoporous zeolite Beta intermediate material, and/or the ultimately formed nano-sized mesoporous zeolite Beta may have an average particle size ranging from 10 to 100 nm, such as from 20 nm to 100 nm, from 30 nm to 100 nm, from 40 nm to 100 nm, from 50 nm to 100 nm, from 60 nm to 100 nm, from 70 nm to 100 nm, from 80 nm to 100 nm, from 90 nm to 100 nm, from 10 nm to 80 nm, from 10 nm to 70 nm, from 10 nm to 60 nm, from 10 nm to 50 nm, from 10 nm to 40 nm, from 10 nm to 30 nm, or from 10 nm to 20 nm. The nano-sized zeolite Beta described herein may form as particles that may be generally spherical in shape or irregular globular shaped (that is, non-spherical). In embodiments, the particles have a “particle size” measured as the greatest distance between two points located on a single zeolite particle. For example, the particle size of a spherical particle is equal to its diameter. In other shapes, the particle size is measured as the distance between the two most distant points of the same particle, where these points may lie on outer surfaces of the particle. Average particle size can be determined using Scanning Electron Microscopy (“SEM”), where the particle size is measured as the longest distance in any dimension of a particle.

Without being bound by theory, it is believed that the relatively small particle size allows for easier access by the molecules in heavy oil to active sites on the zeolite. For example, the increased external surface area may be caused by the small particle size, which may increase catalytic activity.

As described herein, in one or more embodiments, a precursor nano-sized zeolite Beta is heated in a high inert gas concentration environment. As described herein, a “precursor nano-sized zeolite Beta” refers to a nano-sized zeolite Beta that has not yet been heated following its formation to a degree which would substantially burn off organic species in the zeolite. According to embodiments, the precursor nano-sized zeolite Beta may be produced, purchased, or otherwise provided. The precursor nano-sized zeolite Beta may be mesoporous (i.e., having an average pore size of from 2 nm to 50 nm) or may be microporous. In general, the precursor nano-sized zeolite Beta includes organic species, such as templating agents, which are a remnant from the formation of the precursor nano-sized zeolite Beta, as described herein.

According to one or more embodiments, the precursor nano-sized zeolite Beta may be produced by forming a mixture comprising a templating agent, a silica source material, an alumina source material, and water, and hydrothermally treating the mixture containing at least the templating agent, the silica source material, the alumina source material, and water to form the precursor nano-sized zeolite Beta. As described herein, “hydrothermal treatment” refers to treatment under heat in a humid environment, such as in an autoclave. Such a process may be synonymous with steam treating or autoclaving. Following the hydrothermal treatment, the nano-sized zeolite Beta may be separated from the remaining liquids, washed, and/or dried.

According to some embodiments, the templating agent may be an organic compound, such as a quaternary ammonium salt such, as tetraethylammonium hydroxide (TEAOH). Other contemplated templating agents include, without limitation, tetraethylammonium bromide. In one or more embodiments, the silica source material may comprise sodium silicate, fumed silica, precipitated silica, colloidal silica, silica gels, zeolites, dealuminated zeolites, rice husk, silicon hydroxides, silicon alkoxides, or combinations thereof. In one or more embodiments, the alumina source material may comprise aluminates, alumina (e.g. powdered alumina), aluminum colloids, boehmites, pseudo-boehmites, aluminum hydroxides, aluminum salts, aluminum alkoxides, aluminum wire, alumina gels, zeolites, or combinations thereof.

According to one or more embodiments, the mixture containing at least the templating agent (such as TEAOH), the silica source material, the alumina source material, and water may have a molar ratio of these contents of 1 mole of the alumina source material, from 15 moles to 40 moles of the quaternary ammonium salt (such as from 15 moles to 30 moles, or from 30 moles to 40 moles), from 20 moles to 500 moles of the silica source material (such as from 20 moles to 250 moles, or from 250 moles to 500 moles), and from 500 moles to 1000 moles of water (such as from 500 moles to 750 moles, or from 750 moles to 1000 moles).

In embodiments, the mixture containing at least the quaternary ammonium salt, the silica source material, the alumina source material, and water may be hydrothermally treated (e.g., by autoclave) for 1 to 7 days at, for example, 40 rotations per minute (rpm) to 80 rpm (such as about 60 rpm) at 100° C. to 150° C. (such as from 130° C. to 150° C., or about 140° C.) to form the precursor nano-sized zeolite Beta. The hydrothermal treatment may effectively crystalize the source materials to form the zeolite. Without being bound by theory, the amount of agitation during hydrothermal treatment may affect zeolite particle size.

In some embodiments, prior to hydrothermal treatment, the mixture containing at least the templating agent, the silica source material, the alumina source material, and water may be aged, such as by stirring for 4 hours at room temperature, prior to hydrothermal treatment. It should be understood that the described autoclaving and aging steps may be modified to some degree depending upon the exact components of the mixture that is autoclaved and the desired zeolite crystal structure to be formed.

Following the hydrothermal treatment, the resulting precursor nano-sized zeolite Beta may be separated from the remaining liquids, washed, and/or dried. The separation may be by centrifuge, or any other suitable liquid/solids separation technique. Washing may be with deionized water until the pH level is lower than 9.0. Drying may comprise passive drying or heating in an oven at, for example about 110° C. (such as 50° C. to 150° C.).

As described hereinabove, according to embodiments, the precursor nano-sized zeolite Beta may be heated in an environment comprising 99 mol. % or greater inert gas. Such heating may comprise exposure of the precursor nano-sized zeolite Beta to temperatures suitable for decomposing organic matter, such as 550° C. or greater for a time period of from 1 hour to 6 hours.

As described herein, the inert gas may be chosen from nitrogen, helium, or argon. The combination of these gases may constitute the 99 mol. % of inert gas. In other embodiments, a single gas chosen from nitrogen, helium, or argon constitute the 99 mol. % of inert gas. In some embodiments, the environment in which the precursor nano-sized zeolite Beta is heated comprises 99.9 mol. % or greater inert gas.

In some embodiments, the heating in the environment comprising 99 mol. % or greater inert gas may comprise a first heating stage and a second heating stage following the first heating stage. The first heating stage may be at a temperature of from 300° C. to 450° C. for a time period of from 1 hour to 4 hours (such as from 300° C. to 350° C., from 300° C. to 400° C., from 350° C. to 450° C., or from 400° C. to 500° C. for 1-2 hours, 1-3 hours, 2-3 hours, or 3-4 hours). The second heating stage may be at a temperature of from 550° C. to 650° C. for a time period of from 1 hour to 6 hours (such as from 550° C. to 575° C., from 550° C. to 600° C., from 550° C. to 625° C., from 575° C. to 650° C., from 600° C. to 650° C., or from 625° C. to 650° C. for 1-2 hours, 1-3 hours, 1-4 hours, 2-5 hours, 3-5 hours, or 4-5 hours).

Without being bound by theory, the heating in inert gas may decompose the majority of organic compounds, such as the templating agent, that are within the pores of the zeolite Beta, thus increasing the average pore size, according to some embodiments. Additionally, it is believed that utilizing an inert gas environment during heating preserves zeolite crystallinity, especially compared with comparative embodiments that utilize heating under air to burn off organic compounds by calcining. It is believed that such calcining may cause non-framework aluminum species to form on the calcined nano-sized mesoporous zeolite Beta intermediate material. In particular, without being bound by theory, it is believed that Al species are generated due to dealumination, and some pores or channels are blocked by the species, and that during the calcining of zeolite Beta, the templating agent (such as TEAOH) in cages or channels of the zeolite Beta is decomposed. In air, the TEAOH is decomposed via Hoffman elimination reactions: (C₂H₅)₄N⁺OH⁻→C₂H₄+(C₂H₅)₃N+H₂O. Still without being bound by theory, it is believed that produced water becomes steam, and leads to dealumination and partially destroys the zeolite framework structure. However, if the zeolite heating is carried out in an inert gas (such as nitrogen, helium, or argon), the products desorbed are the same as in air, except no oxidation reactions occur. According to embodiments, most templating agent is removed in inert gas, and then changed to air environment to burn a small amount of remaining template.

As described, according to one or more embodiments, the heating under inert gas may form the inert gas-treated nano-sized mesoporous zeolite Beta intermediate material. As described herein, “intermediate material” refers to a material that is later processed, such as by the heating under oxygen described herein. Such inert gas-treated nano-sized mesoporous zeolite Beta intermediate material may then be heated in an environment comprising 10 mol. % or greater oxygen gas, such as air, sometimes referred to as calcination or calcining. This heating under oxygen may form the nano-sized mesoporous zeolite Beta.

According to embodiments, the inert gas-treated nano-sized mesoporous zeolite Beta intermediate material may be heated at a temperature of from 600° C. to 700° C., such as from 600° C. to 675° C., from 600° C. to 650° C., from 600° C. to 625° C., from 625° C. to 700° C., from 650° C. to 700° C., or from 675° C. to 700° C. The time of heating may be from 2 hours to 5 hours, such from 3 hours to 5 hours, from 4 hours to 5 hours, from 2 hours to 4 hours, or from 2 hours to 3 hours.

Without being bound by theory, any remaining organics, following heating under inert gas as described herein, may be burned off in the heating under oxygen and/or air. For example, the majority of the organic templating agent may be decomposed during the heating in the environment comprising 99 mol. % or greater inert gas, and the remainder of the organic templating agent may be decomposed during the heating in the environment comprising 10 mol. % or greater oxygen gas.

According to embodiments, the environment for heating may comprise 10 mol. % or greater oxygen, or even 20 mol. % or greater oxygen. In some embodiments, the environment is heated air or oxygen enriched air.

In some embodiments, the formed inert gas-treated nano-sized mesoporous zeolite Beta intermediate material may be cooled to a temperature of from 100° C. to 300° C., such as from 150° C. to 250° C., or from 175° C. to 225° C. between the heating under inert conditions and the heating under oxygen.

According to embodiments, the presently disclosed methods may not utilize a structure-directing agent, which may be costly and undesirable. Such structure directing agents may be organic nitrogen-containing structure directing agent, such as amines, such as diethylamine or 1,6-diaminohexane, an alkanolamine, such as diethanolamine, 1,8-diamino-octane, N-Ethylpyridine, or a tetraalkyl ammonium compound, such as tetrapropylammonium hydroxide (TPAOH).

As described herein, the crystallinity of the produced nano-sized mesoporous zeolite Beta may be similar to that of the precursor nano-sized zeolite Beta. For example, the nano-sized mesoporous zeolite Beta may have a relative crystallinity of 95% or greater with respect to the crystallinity of the precursor nano-sized zeolite Beta.

In one or more embodiments, the nano-sized mesoporous zeolite Beta described herein may have an average pore volume of 0.9 mL/g or greater, such as from 0.9 to 3.0 mL/g, from 1 to 3.0 mL/g, from 1.1 to 3.0 mL/g, or from 1.2 to 3.0 mL/g. As used in this disclosure, “pore volume” refers to the total pore volume measured using BET analysis. Without being bound they theory, it is believed that the relatively large pore size (that is, mesoporosity) of the presently described nano-sized mesoporous zeolite Beta and catalysts that include the nano-sized mesoporous zeolite Beta allows for larger molecules to diffuse inside the zeolite, which is believed to enhance the reaction activity and selectivity of the zeolite. With the increased pore size, aromatic containing molecules can more easily diffuse into the zeolite and aromatic cracking may be increased. For example, in some conventional embodiments, the feedstock converted by the zeolites may be vacuum gas oils, light cycle oils from, for example, a fluid catalytic cracking reactor, or coker gas oils from, for example, a coking unit. The molecular sizes in these oils are relatively small compared to those of heavy oils such as crude and atmosphere residue, which may be the feedstock of the presently described methods and systems. The heavy oils generally are not able to diffuse inside the conventional zeolites to be converted on the active sites located inside the zeolites. Therefore, zeolites with larger pore sizes (that is, mesoporous zeolites) may make the larger molecules of heavy oils overcome the diffusion limitation, and may make possible reaction and conversion of the larger molecules of the heavy oils.

In additional embodiments, the nano-sized, mesoporous zeolites described herein may have an average surface area of 600 m²/g or greater, such as from 600 m²/g to 700 m²/g. For example, embodiments of the nano-sized, mesoporous zeolite Beta may have a surface area of from 500 m²/g to 550 m²/g, from 500 m²/g to 600 m²/g, from 500 m²/g to 650 m²/g, from 550 m²/g to 700 m²/g, from 600 m²/g to 700 m²/g, or from 650 m²/g to 700 m²/g. Average surface area can be measured by BET analysis. Increased surface area may increase catalytic effectiveness, and is generally desirable.

According to one or more embodiments, the produced nano-sized, mesoporous zeolites described herein may be utilized in hydrocracking operations. Hydrocracking is a process combining catalytic cracking and hydrogenation, wherein heavier feedstocks are cracked in the presence of hydrogen to produce more desirable products. This is an important technology for producing high-value naphtha or distillate products from a wide range of refinery feedstocks. According to embodiments, hydrocracking catalysts may utilize zeolite Beta as their cracking component. The high acidity and hydrothermal stability of zeolite Beta make it a desirable catalyst component in hydrocracking, fluid catalytic cracking, hydrotreating, and isobutene alkylation.

The present disclosure includes numerous, non-limiting technical aspect, listed below as Aspects 1-15.

Aspect 1. A method for making nano-sized mesoporous zeolite Beta, the method comprising: heating, in an environment comprising 99 mol. % or greater inert gas, a precursor nano-sized zeolite Beta to form an inert gas-treated nano-sized mesoporous zeolite Beta intermediate material, wherein the inert gas is chosen from nitrogen, helium, argon, or combinations thereof; heating, in an environment comprising 10 mol. % or greater oxygen gas, the inert gas-treated nano-sized mesoporous zeolite Beta intermediate material to form the nano-sized mesoporous zeolite Beta.

Aspect 2. The method of aspect 1, wherein the heating in the environment comprising 99 mol. % or greater inert gas comprises exposing the precursor nano-sized zeolite Beta to temperatures of 550° C. or greater.

Aspect 3. The method of any previous aspect, wherein the heating in the environment comprising 99 mol. % or greater inert gas comprises a first heating stage and a second heating stage following the first heating stage, wherein: the first heating stage is at a temperature of from 300° C. to 450° C. for a time period of from 1 hour to 4 hours; and the second heating stage is at a temperature of from 550° C. to 650° C. for a time period of from 1 hour to 6 hours.

Aspect 4. The method of any previous aspect, wherein the environment comprising 99 mol. % or greater inert gas comprises 99 mol. % nitrogen.

Aspect 5. The method of any previous aspect, wherein the environment in which the precursor nano-sized zeolite Beta is heated comprises 99.9 mol. % or greater inert gas.

Aspect 6. The method of any previous aspect, wherein the environment in which the precursor nano-sized zeolite Beta is heated comprises 99.9 mol. % or greater nitrogen.

Aspect 7. The method of any previous aspect, wherein the environment in which the inert gas-treated nano-sized mesoporous zeolite Beta intermediate material is heated comprises 20 mol. % or greater oxygen gas.

Aspect 8. The method of any previous aspect, wherein the environment in which the inert gas-treated nano-sized mesoporous zeolite Beta intermediate material is heated consists of air.

Aspect 9. The method of any previous aspect, wherein the heating in the environment comprising 10 mol. % or greater oxygen gas comprises exposing the inert gas-treated nano-sized mesoporous zeolite Beta intermediate material to temperatures of 600° C. or greater.

Aspect 10. The method of any previous aspect, wherein the precursor nano-sized zeolite Beta comprises an organic templating agent.

Aspect 11. The method of aspect 10, wherein the organic templating agent is tetraethylammonium hydroxide.

Aspect 12. The method of aspect 10, wherein the majority of the organic templating agent is decomposed during the heating in the environment comprising 99 mol. % or greater inert gas.

Aspect 13. The method of aspect 12, wherein a remainder of the organic templating agent is decomposed during the heating in the environment comprising 10 mol. % or greater oxygen gas.

Aspect 14. The method of any previous aspect, further comprising producing the nano-sized zeolite Beta precursor by a process comprising hydrothermally treating a mixture comprising a templating agent, a silica source material, an alumina source material, and water.

Aspect 15. The method of aspect 14, wherein the templating agent is tetraethylammonium hydroxide, the silica source material is fumed silica, and the aluminum source material is aluminum powder.

Aspect 16. The method of aspect 14, wherein the process for producing the nano-sized zeolite Beta further comprises separating the precursor nano-sized zeolite Beta from remaining liquids, washing the precursor nano-sized zeolite Beta, and drying the precursor nano-sized zeolite Beta.

Aspect 17. The method of any previous aspect, wherein the nano-sized mesoporous zeolite Beta has an average particle size of from 10 nm to 100 nm.

Aspect 18. The method of any previous aspect, wherein the nano-sized mesoporous zeolite Beta has an average surface area of 600 m²/g or greater.

Aspect 19. The method of any previous aspect, wherein the nano-sized mesoporous zeolite Beta has pore volume of 0.9 ml/g or greater.

Aspect 20. The method of any previous aspect, wherein the nano-sized mesoporous zeolite Beta has a relative crystallinity of 95% or greater with respect to the crystallinity of the precursor nano-sized zeolite Beta.

### EXAMPLES

The various embodiments of the methods of the present disclosure will be further clarified by the following examples. The examples are illustrative in nature, and should not be understood to limit the subject matter of the present disclosure.

### Example 1—Preparation of Precursor Nano-Sized Zeolite Beta Samples (Sample NanoB)

A non-calcined nano-sized zeolite Beta, termed Sample NanoB herein, was fabricated that was further heated in additional examples. The sample were prepared according to embodiments disclosed in Alotaibi et al. “A facile synthesis of hierarchical Nanosized Beta and its application in direct crude oil hydrocracking,” Catalyst Communications 2024, Vol. 187, 106871.

To make Sample NanoB, aluminum metal was dissolved in a TEAOH-containing aqueous solution, resulting in the formation of a transparent solution. Subsequently, this solution was introduced into a slurry composed of fumed silica and another portion of the TEAOH-containing aqueous solution. The silica source used was fumed silica (Degussa, Acrosil 200), whereas the aluminum source employed was aluminum powder. Additionally, tetraethylammonium hydroxide (TEAOH) (Aldrich, 35% aqueous solution) was utilized as the templating agent. The precursor gel was composed of oxides with the following molar ratio: 30TEAOH:50SiO₂:Al₂O₃:750H₂O. The aluminosilicate fluid gel that was created was agitated in a beaker at room temperature for 4 hours. Following, it was placed into a Teflon-lined autoclave. The process of crystallization was conducted at a temperature of 140° C. in a rotational state at a speed of 60 rpm for 3 days. The autoclave was subjected to quenching to stop the crystallization reaction. The separation of the finished product from the liquid was achieved by using a centrifuge operating at a speed of 16,000 rpm. Subsequently, the separated product underwent a washing process using deionized water until the pH level reached a value lower than 9.0. Finally, the product was subjected to a drying procedure in an oven at a temperature of 110° C.

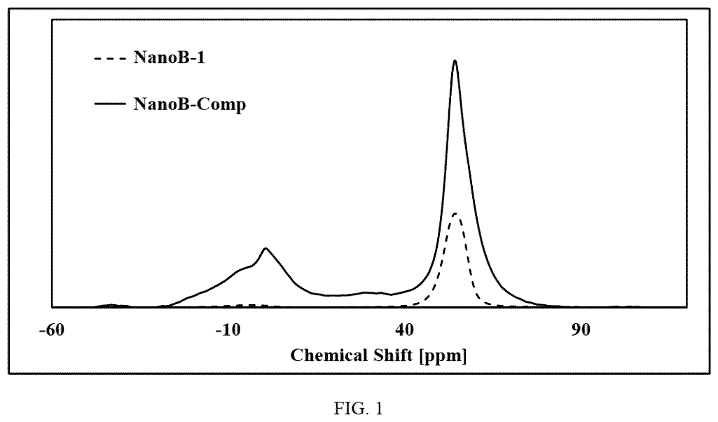

Additionally, both Samples NanoB and NanoB-HT were observed to be particles having diameters of about 30 nm. FIG. 1 depicts a TEM image of such particles.

### Comparative Example A—Heating in Air of Precursor Nano-Sized Zeolite Beta Sample (NanoB-Ref)

In Comparative Example A, 4 g of Sample NanoB was calcined in air to form Sample NanoB-Comp. Specifically, Sample NanoB was calcined at 650° C. (ramp rate of 2° C./min) for 4 hours to remove the organic agents (e.g., the TEAOH). Specifically, air was introduced into a furnace via a stainless-steel tube at 200 ml/min. After heating in air for 4 hours, the furnace was cooled to room temperature and the air flow was halted.

### Example 2—Heating in Air Followed by Nitrogen of Precursor Nano-Sized Zeolite Beta Sample (NanoB-1, NanoB-2, NanoB-3)

In Example 2, three samples were produced by heating the Sample NanoB material in a nitrogen environment followed by heating in air, where different heating conditions were utilized in each sample. These three Samples are named NanoB-1, NanoB-2, and NanoB-3.

For making each of NanoB-1, NanoB-2, and NanoB-3, 4 g of Sample NanoB was placed into a furnace and nitrogen gas was introduced through a stainless steel tube into the furnace. The nitrogen gas flowrate was 200 ml/min. In a first nitrogen heating stage: for Sample NanoB-1 the furnace temperature was raised to 350° C. at a ramp rate of 2° C./min, and maintained at 380° C. for 2 hours; for Sample NanoB-2 the furnace temperature was raised to 400° C. at a ramp rate of 2° C./min, and maintained at 400° C. for 2 hours; and for Sample NanoB-3 the furnace temperature was raised to 380° C. at a ramp rate of 2° C./min, and maintained at 400° C. for 2 hours. Then, in a second nitrogen heating stage: for Sample NanoB-1 the furnace temperature was raised to 600° C. at a ramp rate of 1° C./min, and maintained at 600° C. for 4 hours; for Sample NanoB-2 the furnace temperature was raised to 600° C. at a ramp rate of 0.5° C./min, and maintained at 600° C. for 4 hours; and for Sample NanoB-3 the furnace temperature was raised to 600° C. at a ramp rate of 0.8° C./min, and maintained at 600° C. for 4 hours. Following the second nitrogen heating stage, in all of samples NanoB-1, NanoB-2, and NanoB-3, the furnace was cooled to 200° C. and the nitrogen gas supply was switched to air at the same flow rate. Then, in an air heating stage, in all of samples NanoB-1, NanoB-2, and NanoB-3, the furnace temperature was raised to 650° C. at a ramp rate of 2° C./min, and maintained at 650° C. for 4 hours, followed by cooling to room temperature and halting air flow into the furnace. A summary of the treatments in provided in Table 1.

### Example 3—Characterization of Produced Samples

The produced samples were analyzed for various properties, shown in Table 1. Surface area, pore volume, and average pore size were determined by Brunauer-Emmett-Teller (“BET”) analysis, and molar ratio of silica to alumina was determined by ²⁷Al NMR. Relative crystallinity was determined by X-ray Diffraction (“XRD”) with the sample NanoB being the baseline at “100%” crystallinity, to which all other samples were compared.

The relative crystallinity of the various zeolite Betas were analyzed by XRD using a diffractometer, such as a Rigaku Ultima IV multi-purpose diffractometer with a copper X-ray tube available from Rigaku Corporation of Tokyo, Japan. The scanning range was set between 2° to 50° in 20 Bragg-angles with a step size of 0.04° and a total counting time of 1° per minute. The crystallinity percentage was calculated by PANalytical High Score Plus software available from Malvern Panalytical of Mavern, Worcestershire, United Kingdom, through the comparison of the area under the most intense diffraction peaks to that of patterns of a reference zeolite beta.

TABLE 1

| | Sample Name | | | | |
|---|---|---|---|---|---|
| | | | NanoB-1 | NanoB-2 | NanoB-3 |
| | NanoB | | NanoB | NanoB | NanoB |
| | Non- | NanoB-Comp | heated in | heated in | heated in |
| | Calcined | Calcinated | Nitrogen | Nitrogen | Nitrogen |
| | Nano-sized | NanoB | followed by | followed by | followed by |
| Description | Zeolite Beta | in Air | Calcination | Calcination | Calcination |
| First stage Heating (Nitrogen) | No | No | Yes | Yes | Yes |
| Heating to temperature, ° C. | N/A | N/A | 350 | 400 | 380 |
| Heating rate, ° C./min | N/A | N/A | 2 | 2 | 2 |
| Time maintained at final temp, h | N/A | N/A | 2 | 2 | 2 |
| Second stage Heating (Nitrogen) | No | No | Yes | Yes | Yes |
| Heating to temperature, ° C. | N/A | N/A | 600 | 600 | 600 |
| Heating rate, ° C./min | N/A | N/A | 1 | 0.5 | 0.8 |
| Time maintained at final temp, h | N/A | N/A | 4 | 4 | 4 |
| Heating in Air | No | Yes | Yes | Yes | Yes |
| Heating to temperature, ° C. | N/A | 650 | 650 | 650 | 650 |
| Heating rate, ° C./min | N/A | 2 | 2 | 2 | 2 |
| Time maintained at final temp, h | N/A | 4 | 4 | 4 | 4 |
| Relative Crystallinity | 1 | 0.9 | 0.97 | 0.98 | 0.99 |
| SiO₂/Al₂O₃ Molar Ratio | 22.8 | 22.9 | 22.9 | 22.8 | 22.8 |
| Surface area, m²/g | 590 | 547 | 592 | 600 | 601 |
| Pore volume, ml/g | 0.83 | 1.15 | 1.01 | 1.13 | 1.13 |
| Average pore size, nm | 2.8 | 8.3 | 6.8 | 7.5 | 7.5 |

As can be seen from the data in Table 1, the heating under nitrogen prior to calcining in air leads to higher crystallinity in the formed zeolites. Higher surface area also resulted from utilizing the nitrogen treatment, while pore volume and pore size were not decreased by a great deal, and within acceptable limits for the desired uses of the zeolite Beta produced.

Additionally, the ²⁷Al NMR shown in FIG. 1 depicts data for samples NanoB-Comp and NanoB-1. The data indicates that a considerable amount of non-framework Al species are produced after calcination in air in NanoB-Comp, as shown by the high peaks at 0 ppm. However, for Samples NanoB-1, which was first heating in nitrogen, no peaks are observed at a chemical shift of 0 ppm, indicating that no non-framework Al species were generated.

For the purposes of describing and defining the present disclosure it is noted that the terms “about” or “approximately” are utilized in this disclosure to represent the inherent degree of uncertainty that may be attributed to any quantitative comparison, value, measurement, or other representation. The terms “about” and/or “approximately” are also utilized in this disclosure to represent the degree by which a quantitative representation may vary from a stated reference without resulting in a change in the basic function of the subject matter at issue.

It is noted that one or more of the following claims utilize the term “wherein” as a transitional phrase. For the purposes of defining the present technology, it is noted that this term is introduced in the claims as an open-ended transitional phrase that is used to introduce a recitation of a series of characteristics of the structure and should be interpreted in like manner as the more commonly used open-ended preamble term “comprising.”

Any quantitative value expressed in the present application may be considered to include open-ended embodiments consistent with the transitional phrases “comprising” or “including” as well as closed or partially closed embodiments consistent with the transitional phrases “consisting of” and “consisting essentially of.”

It is also noted that recitations herein of “at least one” component, element, etc., should not be used to create an inference that the alternative use of the articles “a” or “an” should be limited to a single component, element, etc.

What is claimed is:

1. A method for making nano-sized mesoporous zeolite Beta, the method comprising:
heating, in an environment comprising 99 mol. % or greater inert gas, a precursor nano-sized zeolite Beta to form an inert gas-treated nano-sized mesoporous zeolite Beta intermediate material, wherein the inert gas is chosen from nitrogen, helium, argon, or combinations thereof; and
heating, in an environment comprising 10 mol. % or greater oxygen gas, the inert gas-treated nano-sized mesoporous zeolite Beta intermediate material to form the nano-sized mesoporous zeolite Beta.

2. The method of claim 1, wherein the heating in the environment comprising 99 mol. % or greater inert gas comprises exposing the precursor nano-sized zeolite Beta to temperatures of 550° C. or greater.

3. The method of claim 1, wherein the heating in the environment comprising 99 mol. % or greater inert gas comprises a first heating stage and a second heating stage following the first heating stage, wherein:
the first heating stage is at a temperature of from 300° C. to 450° C. for a time period of from 1 hour to 4 hours; and
the second heating stage is at a temperature of from 550° C. to 650° C. for a time period of from 1 hour to 6 hours.

4. The method of claim 1, wherein the environment comprising 99 mol. % or greater inert gas comprises 99 mol. % nitrogen.

5. The method of claim 1, wherein the environment in which the precursor nano-sized zeolite Beta is heated comprises 99.9 mol. % or greater inert gas.

6. The method of claim 1, wherein the environment in which the precursor nano-sized zeolite Beta is heated comprises 99.9 mol. % or greater nitrogen.

7. The method of claim 1, wherein the environment in which the inert gas-treated nano-sized mesoporous zeolite Beta intermediate material is heated comprises 20 mol. % or greater oxygen gas.

8. The method of claim 1, wherein the environment in which the inert gas-treated nano-sized mesoporous zeolite Beta intermediate material is heated consists of air.

9. The method of claim 1, wherein the heating in the environment comprising 10 mol. % or greater oxygen gas comprises exposing the inert gas-treated nano-sized mesoporous zeolite Beta intermediate material to temperatures of 600° C. or greater.

10. The method of claim 1, wherein the precursor nano-sized zeolite Beta comprises an organic templating agent.

11. The method of claim 10, wherein the organic templating agent is tetraethylammonium hydroxide.

12. The method of claim 10, wherein the majority of the organic templating agent is decomposed during the heating in the environment comprising 99 mol. % or greater inert gas.

13. The method of claim 12, wherein a remainder of the organic templating agent is decomposed during the heating in the environment comprising 10 mol. % or greater oxygen gas.

14. The method of claim 1, further comprising producing the nano-sized zeolite Beta precursor by a process comprising hydrothermally treating a mixture comprising a templating agent, a silica source material, an alumina source material, and water.

15. The method of claim 14, wherein the templating agent is tetraethylammonium hydroxide, the silica source material is fumed silica, and the aluminum source material is aluminum powder.

16. The method of claim 14, wherein the process for producing the nano-sized zeolite Beta further comprises separating the precursor nano-sized zeolite Beta from remaining liquids, washing the precursor nano-sized zeolite Beta, and drying the precursor nano-sized zeolite Beta.

17. The method of claim 1, wherein the nano-sized mesoporous zeolite Beta has an average particle size of from 10 nm to 100 nm.

18. The method of claim 1, wherein the nano-sized mesoporous zeolite Beta has an average surface area of 600 m²/g or greater.

19. The method of claim 1, wherein the nano-sized mesoporous zeolite Beta has pore volume of 0.9 ml/g or greater.

20. The method of claim 1, wherein the nano-sized mesoporous zeolite Beta has a relative crystallinity of 95% or greater with respect to the crystallinity of the precursor nano-sized zeolite Beta.
